(19) United States
(12) Patent Application Publication
(10) Pub. No.: US 2008/0205719 A1
(43) Pub. Date: Aug. 28, 2008

(54) Method of Model-Based Elastic Image Registration For Comparing a First and a Second Image

(75) Inventors: Vladimir Pekar, Hamburg (DE); Ingwer-Curt Carlsen, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,155

(22) PCT Filed: Jun. 14, 2006
(86) PCT No.: PCT/IB2006/051906

§ 371 Date: Dec. 11, 2007

(30) Foreign Application Priority Data
Jun. 15, 2005 (EP) 05105238.9

(51) Int. Cl. G06K 9/00

(52) U.S. Cl. 382/128

(57) ABSTRACT

The invention aims at improving the point-based elastic registration paradigm. Point-based elastic registration is typically carried out by finding corresponding point landmarks (2, 4) in both images and using the point correspondences as constraints to interpolate the global displacement field. A limitation of this approach is that it only ensures the correspondences between structures where point landmarks (2, 4) can be identified. Alternative concepts are limited by high computational costs for optimization. The concept of the invention provides a method and a system (1) wherein additional deformation field constraints are imposed by: partitioning (PART (I_{S}, I_{T})) one or more restricted structures corresponding in the first (3) and the second (5) image and imposing additional constraints (f^{Add}ₚₐᵣₜ) derived from a-priori-knowledge to the one or more restricted structures. Preferred examples are i) pairs of interactively defined point landmarks (25), ii) landmarks resulting from automatic identification of corresponding structures in form of a line (23) or an area (27) or a form or a boundary (29, FIG. 3) thereof, iii) different material properties (tissue1, tissue2) of corresponding structures, iv) physiological constraints establishing more general correspondences.

The invention relates to a method of model-based elastic image registration for comparing a first and a second image, in particular for a medical and/or a biomedical application.

The invention also relates to a respective system for model-based elastic image registration for comparing a first and a second image, in particular for a medical and/or biomedical application.

Also the invention relates to an image acquisition device, an image workstation and a computer program product and an information carrier.

Image registration is an important procedure in medical image analysis, aiming at obtaining complementary information from different representations of the same anatomy. The goal of image registration is to find a transformation bringing the anatomy in the source and target image into best possible spatial correspondence. Many algorithms using rigid and affine transformations exist, which are significantly simpler than those using non-linear transformations, but whose application range is limited. Only few potentially feasible solutions using non-linear transformations exist despite many years of active research. Point-based (landmark-based) elastic registration can be carried out by automatically finding corresponding point landmarks in both images and using the point landmark correspondences as constraints to interpolate or approximate the global displacement field as for instance described in “Medical Image Registration”, J. V. Hajnal, D. L. G. Hill and D. J. Hawkes (eds.) CRC Press, 2001. A limitation of this approach is that it only ensures the correspondences between structures where landmarks can be automatically identified. The similarity between the images is maximized only if a very dense point landmark distribution is used, otherwise the registration quality may be poor.

A challenging problem in deformable image registration therefore is, coping with the complexity of the underlying non-linear transformations, often resulting in prohibitive computational costs for the practical use. The use of non-parametric transformations may, for example, lead to optimization problems with several million unknowns, where only a few efficient solutions are known in the literature. One is for instance described in “Fast fluid registration of medical images”, Bro-Nielsen, M., Gramkow, C. in: Proc. Visualization in Biomedical Computing (VBC'96), Hamburg (1996) 267-276; or “Fast image registration—a variational approach”, Fischer, B., Modesitzki, J. in: Proc. of the Int. Conf. on Numerical Analysis and Computational Mathematics (NACoM'03), Cambridge (2003) 69-74.

An advantage of parametric methods is the ability to represent non-linear transformations with a moderate number of parameters. One example is deformable registration based on regular B-spline grids as for instance described in “Spline-Based Elastic Image Registration”, Karl Rohr, PAMM, Vol. 3, Issue 1, pages 36-39, published online: Nov. 28, 2000. However, the performance thereof is highly dependent on the grid resolution, with fine grids leading to a high-dimensional search space and coarse grids leading to improper registration of small structures.

A further improvement has been proposed in “Deformable Image Registration by Adaptive Gaussian Forces”, V. Pekar, E. Gladilin in: Proc. ECCV 2004, Workshops CVAMIA and MMBIA, pg 317-328, Prague, Czech republic, May 2004, LNCS 3117 Springer, wherein it is assumed that Gaussian-shaped forces are applied at several independent control points in the image to be deformed. This results in an optimization scheme, where the positions of the control points as well as the optimal force strengths and directions are determined which maximize the similarity between images. This method also allows for controlling the local influence of individual control points by explicitly including the Gaussian standard deviation into the optimization process. The latter approach introduces adaptive irregular grids of control points with limited influence area using a physics-based elastic deformation model. Though this strategy is a promising approach it is limited to homogenous elastic materials wherein the image is considered to be an infinite elastic continuum and limited by high computational costs for optimization and the computational efficiency remains limited.

Desirable is a concept of increased computational efficiency and better results also for inhomogeneous materials.

This is where the invention comes in, the object of which is to provide, in particular for a medical and/or biomedical application, a method and apparatus of model-based elastic image registration for comparing a first and a second image wherein even upon dealing with inhomogeneous materials computational efficiency and result quality is increased.

As regards the method the object is achieved by a method of model-based elastic image registration for comparing a first and a second image comprising the steps of:

determining an optimized elastic deformation field by optimizing a similarity measure between the first and the second image on basis of an adaptive elastic registration,

wherein deformation field constraints are imposed by

automatically providing corresponding control point landmarks in the first and second image

applying adaptive Gaussian-shaped forces as a transformation module at the control point landmarks.

According to the invention the step of imposing deformation field constraints further comprises:

partitioning one or more of corresponding, restricted structures in the first and the second image;

providing additional constraints derived from a-priori-knowledge to the one or more restricted structures.

As regards this apparatus the object is achieved by a system for modul-based elastic image registration for comparing a first and a second image comprising:

means for determining an optimized elastic deformation field by optimizing a similarity measure between the first and the second image on basis of an adaptive elastic registration,

means for imposing deformation field constraints comprising

means for automatically providing corresponding control point landmarks in the first and second image

means for applying adaptive Gaussian-shaped forces as a transformation module at the control point landmarks;

According to the invention the means for imposing deformation field constraints further comprises:

means for partitioning one or more restricted structures corresponding in the first and the second image;

means for providing additional constraints derived from a-priori-knowledge to the one or more restricted structures.

In its basic idea the present invention is directed to improve the elastic registration paradigm by combining the automated optimization procedure for adaptive Gaussian forces with a-priori-knowledge which is applied for restricted structures, correspondingly in the first and the second image, said restricted structures are identified by a proper process of partitioning. Such process may be applied manually, semi-automatically, for instance interactively, or automatically upon use of proper conditions and of a respective system by a user, in particular by a physician.

It has been realized by the invention that tools for partitioning can be effectively implemented to identify restricted structures in an image and subsequently imposing additional constraints derived from a-priori-knowledge to the one or more restricted structures. A-priori-knowledge is available in various forms as will be described in developed configurations of the inventive concept. Furthermore, the concept leads to effective reduction of computational efforts, and therefore combines the advantages of non-linear model-based elastic image registration concepts based on adaptive Gaussian-shaped forces with practical approaches using a-priori-knowledge.

In particular, as compared to commonplace measures a variety of advantages are achieved by the inventive concept.

Firstly a registrational robustness is improved, since it can be guaranteed that certain structures in both, the first (source) image and the second (target) image correspond, which otherwise may be difficult to achieve when applying for instance gray-value-based similarity measures only. As outlined in the introduction, gray-value-based similarity measures lead to problems when landmarks cannot be identified clearly.

Secondly the parameter space of degrees of freedom for optimization is restricted and the use of computationally efficient local optimization methods can be feasible.

Thirdly the inventive concept allows to combine offline global optimization concepts with online local refinement concepts at interactive speed. This is of particular importance for online situations like in surgery. In particular global and local registration accuracy requirement can be adapted to foci on clinical interest and registration can be improved to safely handle highly disparate modalities. E.g. it can be advantageous in certain situations to neglect an optimization of a global similarity measure to the advantage of an optimization of a local similarity measure.

This also leads to a large variety of applications of the instant concept which is not restricted only to medical and/or biomedical applications but may in particular also be extended to applications like molecular imaging.

Developed configurations of the invention are further outlined in the dependent claims of the method and system respectively. Thereby the mentioned advantages of the proposed concept are even more improved and in particular the developed configurations give preferred concepts of introducing a-priori-knowledge.

In a preferred embodiment the partitioning step comprises segmentation of the first and second image. Such segmentation process may be accomplished by various techniques, for instance by a tresholding process or a seed-growing technique.

Preferably, the a-priori-knowledge constraints for the restricted structure are applied as geometrical constraints. Preferred geometrical constraints are imposed by defining a restricted structure in form of a point or a line or an area. Also the form or boundary of an area or a line or a point gives proper geometrical constraints to a restricted structure. The advantage is that geometrical constraints are easy to apply, in particular manually, semi-automatically or automatically if necessary.

In a simplifying preferred configuration additional constraints are imposed as interactively defining corresponding point landmarks in the first and second image. Additional or in combination with another preferred configuration additional constraints can be imposed as landmarks resulting from automatic, semi-automatic or interactive identification of corresponding areas or boundaries in the first and second image. Landmarks in form of a point, line or area can be easy applied for instance by manually selecting point landmarks or by applying automated deformable mesh adaptation in images to be registered wherein the vertices of meshes will provide a desired mapping. Meshes of the mentioned kind are preferably provided by a segmentation process mentioned above. This concept is advantageously applied even in the case that structures cannot clearly be identified automatically, e.g. on the basis of gray-values.

In a further advantageous developed configuration the a-priori-knowledge constraints for the restricted structure are applied as physiological constraints.

As an exemplifying preferred configuration thereof different material properties of corresponding structures may be applied to certain geometric structures in an image. The latter may be outlined by a point or a line or an area or a form or a boundary thereof or the like. Thereby advantageously the inhomogeneous properties of a material are accounted for. For instance different elastic material properties may be given to a first structure of an image as compared to further structures of the image.

As another example physiological relations may be useful establishing constraints which clearly transcend mere geometric reasoning. In particular the latter kind of constraints are preferably applied when no geometric landmark can be identified clearly. For instance spatial neighborhood relations can be established. As another example time constraints based on, for instance, tracer dynamics, can be given to impose a-priori-knowledge constraints. Mathematically such schemes lead to more approximation-like concepts instead of strict interpolation-like concepts for clearly defined structures.

The method and system and developed configurations thereof as outlined above may be implemented by digital circuits of any preferred kind, whereby the advantages associated with digital circuits may be obtained. A single processor or other unit will fulfill the function of several means recited in the claims. A digital circuit processor of the mentioned kind may be implemented in one or more multi-processor systems.

In particular, the inventive concept also leads to an image acquisition device and image workstation each comprising the system as described above.

Also the invention leads to a computer program product storable on a medium readable by a computing, imaging and/or printer system, comprising a software code section which induces the computing, imaging and/or printer system to execute the method as described above when the product is executed on the computing, imaging and/or system.

The invention also leads to an information carrier comprising the computer program product as described above.

These and other aspects of the invention will be apparent from and elucidated with reference to the embodiments described hereinafter.

It is, of course, not possible to describe every conceivable configuration of the components or methodologies for purposes of describing the present invention, but one of ordinary skill in the art will recognize that many further combinations and permutations of the present invention are possible.

In particular, as regards the method, the described embodiments are not mandatory. A person skilled in the art may change the order of steps or perform steps concurrently using threading models, multi-processor systems or multiple processes without departing from the concept as intended by the current invention. The invention can be implemented by means of hardware comprising several distinct elements, and by means of a suitably programmed computer. In particular in claims enumerating several means, several of these means can be embodied by one and the same item of computer readable software or hardware.

Whereas the invention has particular utility for and will be described as associated with a CT acquisition device, it should be understood that the invention is also operable with other forms of imaging devices capable for reproducing volumetric image data. Such imaging device in particular comprise systems for medical acquisition of data like 3D-RA, MR, PET, SPECT etc.

For a more complete understanding of the invention, reference should be made to the accompanying drawing, wherein:

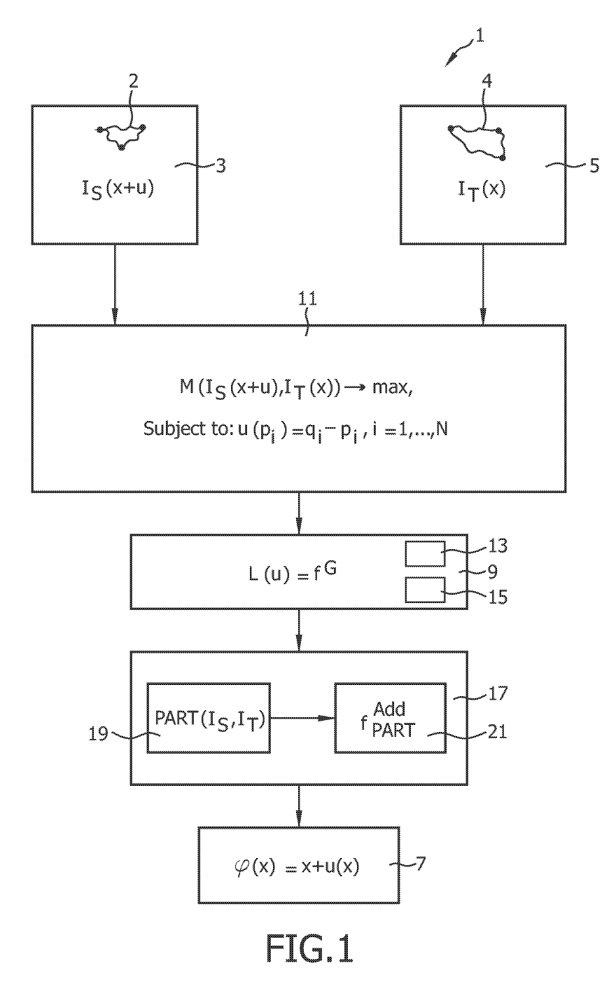

FIG. 1 depicts a diagrammatic scheme of a system for model-based elastic image registration for comparing a first and a second image in a medical and/or biomedical application according to a preferred embodiment of the invention;

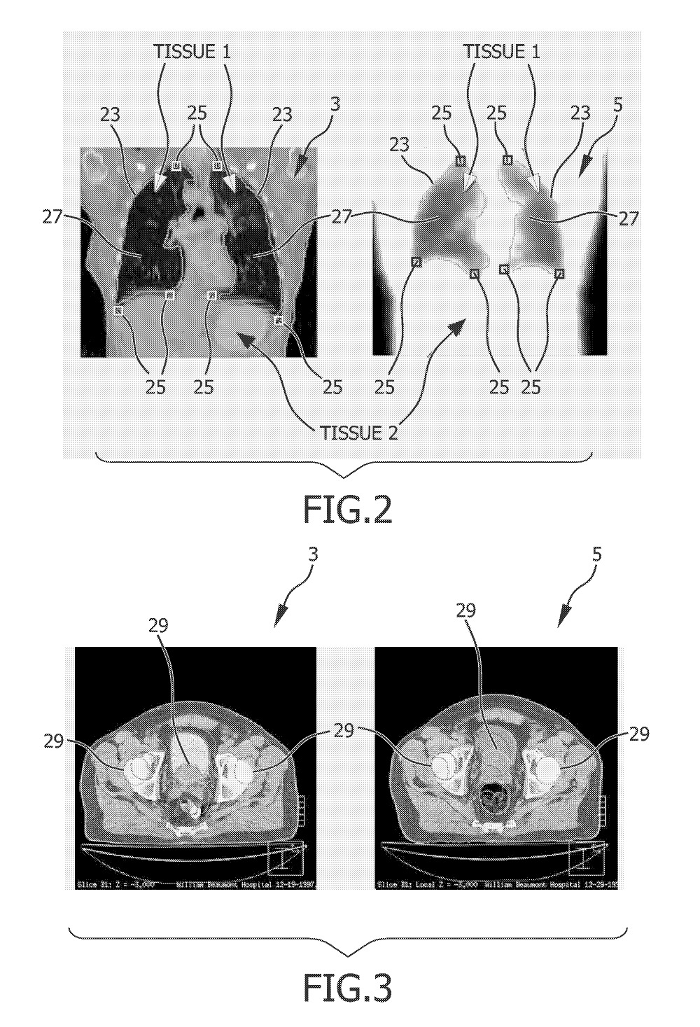

FIG. 2 depicts a source and a target image of a PET/CT registration of a lung wherein the partitioned restricted structure of the lungs are imposed to an additional constraint with regard to material properties and point landmarks are interactively defined, both kinds of constraints are derived from a-priori-knowledge according to a preferred embodiment of the invention;

FIG. 3 depicts a source and a target image of a CT registration with application to radiation therapy of an abdominopelvic as a further anatomical example using a boundary mapping as an additional constraint of a-priori-knowledge in a further preferred embodiment of the invention;

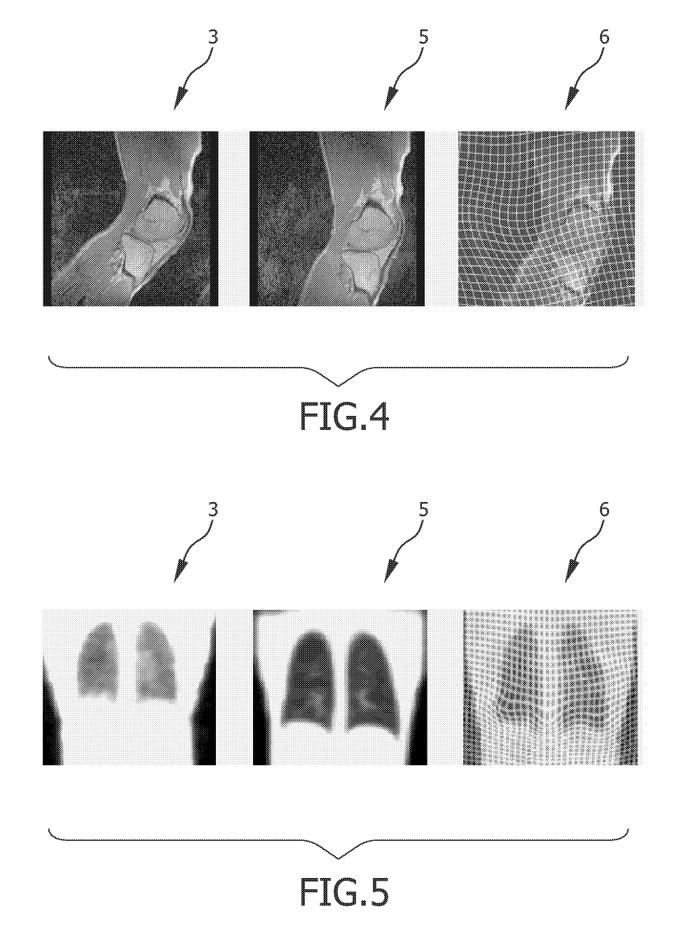

FIG. 4 depicts a source and target image and a respective deformed mesh image of a MRI registration of a knee example wherein a smooth deformation field is used for less compressible materials as an additional a-priori-knowledge constraint according to a further preferred embodiment of the invention;

FIG. 5 depicts images like those of FIG. 4 for a PET/CT registration of a lung wherein an inhomogeneous deformation field is used for more compressible materials as an additional constraint of a-priori-knowledge according to a further preferred embodiment of the invention;

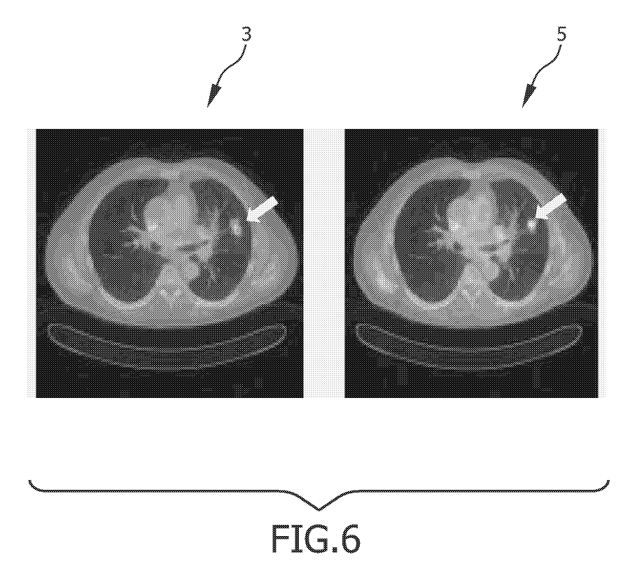

FIG. 6 depicts a source and a target image of a PET/CT registration of a further anatomical example wherein an additional point landmark constraint is used as a-priori-knowledge according to a preferred embodiment of the invention.

As outlined in FIG. 1 the preferred embodiment of the instant invention is directed to physics-based registration of images, i.e. a source image I_{S}(x) indicated by reference mark 3 and a target image I_{T}(x) indicated by reference mark 5. In an elastic image registration for comparing the first image 3 and the second image 5 the images are modeled as physical continua (elastic solid, fluids, etc.) deforming under the application of external forces f. The problem of physics-based registration can be formulated as finding the elastic deformation φ:Ω→ [symbol] ³ in a spatial domain Ω with the boundary ∂Ω(Ω=Ωυ∂Ω). The elastic deformation or displacement field is indicated by reference mark 7. As a basis solving a (generally non-linear) partial differential equation (PDE) of the type indicated by reference mark 9: L(u)=f with the appropriate boundary conditions is used. Here f:Ω→ [symbol] ³ denotes the vector of the applied forces acting on the underlying physical medium. Therein u:Ω→ [symbol] ³ is the displacement field, and L is an operator defining the response of the material. The connection between the elastic deformation and the displacement field is given as φ(x)=x+u(x) by reference mark 7. The optimal elastic deformation is determined by optimizing, in particular maximizing a similarity measure M between a source image I_{S}(x) and a target image I_{T}(x), which is indicated by reference mark 11.

In a preferred embodiment a respective system 1 for model based elastic image registration for comparing a first image 3 and a second image 5 is adapted for a medical and/or biomedical application. Said system 1 comprises means 11 for determining an optimal elastic deformation field 7 by maximizing a similarity measure 11 between the first image I_{S}(x) and the second image I_{T}(x) on basis of an adaptive elastic registration. Deformation constraints are imposed by means 13 for automatically providing control point landmarks 2 in the first image 3 and correspondingly control point landmarks 4 in the second image 5. Additionally, the system 1 provides means 15 for applying adaptive Gaussian-shaped forces f^{G} as a transformation module at the control point landmarks 2, 4.

The position of the landmarks 2, 4, the directions and magnitudes of the applied forces f^{G} as well as their influence areas are optimized to reach a maximum of the similarity measure between the images 3 und 5, i.e. I_{S}(x) and I_{T}(x).

According to the concept of the invention the preferred embodiment of the system 1 provides a means 17 for imposing additional deformation field constraints. The means 17 further comprises means 19 for partitioning one or more of restricted structures, corresponding in the first image 3 and the second image 5; and means 21 for providing additional constraints f^{Add}ₚₐᵣₜ derived from a-priori-knowledge to the one or more restricted structures, like for instance the structures indicated by landmarks 2, 4.

The preferred embodiment of the instant invention as outlined in FIG. 1 reduces the complexity of the solution process and thereby limits computational costs for optimization and increases efficiency of the solution process. Furthermore, the embodiment of the instant invention achieves to perform the registration process also for inhomogeneous materials and still the computational effort is kept low.

This is of essential interest in the development of robust elastic image registration tools in the medical industry and medical workstations. Global elastic registration is required for a variety of clinical applications, where images acquired at different times, with different modalities or different patients have to be aligned. Important examples relate to tumor diagnosis and surgery, where images of different modalities show different aspects of the tumor, comparison of pre- and post-intervention images, analysis of time series of medical images, matching of individual images with anatomical images, etc.

An example of providing a-priori-knowledge in registration of a PET/CT lung study is illustrated in FIG. 2. FIG. 2 shows on the left hand side a first image 3 in form of a CT image and on the right hand side a second image 5 in form of a PET transmission map each with segmented lung outlines 23 and additional point landmarks 25, both serving as additional deformation field constraints. In CT images and PET transmission maps, lung and body outlines can be segmented automatically, for example by using deformable mesh adaptation and corresponding structures identified through a mapping between mesh vertices. The same holds for the pairs of point landmarks 25 which may be defined preferably interactively. Additionally, also point landmarks may be defined automatically. However, the instant embodiment has preferable use in the case point landmarks cannot be defined due to low contrast values or insufficient gray value parameters in an image 3, 5. Defining landmarks 23, 25 interactively, manually or semi-automatically is an essential help to reduce the complexity of the problem to be solved as outlined with regard to FIG. 1.

As a further additional deformation field constraint in the embodiment of FIG. 2 a physiological constraint is imposed to the area 27 defined by the lung outlines 23. Inside the lung outlines 23, i.e. area 27, an elastic property is assigned to tissue1 which is different from the elastic property assigned to the tissue2 outside the lung outlines 23. Consequently, different materials in the image are provided with different material properties of the corresponding structure upon registration of the images 3, 5.

Further examples for imposing deformation field constraints in form of geometrical constraints are numerous. Interventional applications are a good example to illustrate a possible implementation of this technique. During the intervention, pre-operatively acquired images, for instance CT, MR or nuclear images, will have to be registered with online acquired microscopic, endoscopic or ultra-sound images to monitor or plan the interventional procedure. Registration of such disparate modalities and of images that have been acquired under such different circumstances and patient positioning is hard due to the large non-linear deformations to be compensated and due to the lack of sufficient landmarks that can automatically and unambiguously identified in the respective image data. Here, interactively identified landmarks such as fiducial markers, surgical instruments, anatomical structures in conjunction with information extracted from the DICOM header accompanying the pre-operatively acquired images and providing information about patient position, details of the acquisition protocol, the anatomical domain imaged etc. is essential for guiding the adaptive Gaussian registration process towards an acceptable result by providing additional unambiguous landmarks and force field constraints.

A further example of point-to-point correspondences between the boundaries of organs in the images to be registered is given in FIG. 3. The corresponding anatomical structure in a primary image 3 and the follow up image 5 are denoted between regions of different gray-value appearance. Some boundaries 29 are indicated for example as boundaries between bone und tissue or as boundaries between organs.

The boundaries 29 can be registered automatically adapting deformable models for instance triangular meshes to the anatomical structures of interest, where certain mesh vertices can also be used as landmarks. In the latter case also landmarks, which have not a reference mark in FIG. 3, can be registered automatically.

Especially in applications of radiation therapy it may be also preferable to accent local optimization instead of global optimization. In a further improved example e.g. in a first step the proposed concept of the invention can be used to achieve optimized global registration and thereafter, in a second step, to achieve optimized local registration of a certain body organ or another body feature of interest.

A further example of deformation field constraints applied as physiological constraints with regard to the material property is given in FIG. 4 and FIG. 5.

With regard to FIG. 4 a knee and to FIG. 5 the lungs are shown in a first image 3 as a source and a second image 5 as a target next to a respective deformation field 6.

Here, the underlying deformations can give a clue for assigning the material properties. For example, in kinematic studies of joints motion, no substantial local contraction or expansion takes place, therefore incompressible elastic materials like those for the bones of a knee in the MRI registration of FIG. 4 are well suited for a modeling such deformation fields. On the contrary, highly compressible elastic materials are advantageous for registration of PET/CT lung images as shown in FIG. 5, where the breathing motion causes considerable local expansion and/or contraction in the images. An elasticity of less compressible material is favorable in cases where the deformation field is smooth like for instance inside the lungs. More compressible materials where the deformation field is inhomogeneous may be applied to an area outside the lung. This kind of assigning different material properties to individual anatomical structures based on the physical properties like compressibility etc. is a further developed embodiment and has advantages over an over-all assigning of a deformation elasticity for an image. Here a-priori-knowledge about elastic material properties can be derived by explicitly including the Poisson's ratio ν into the optimization procedure. A smooth deformation field (of less compressible materials) can be achieved by ν→0.49. An inhomogenous deformation field (of more compressible materials) can be achieved by ν→0.0. It's optimal value for a specific registration application can be obtained by test runs and then fixed to reduce the dimensionality of the optimization problem.

FIG. 6 depicts a structure where the position of the hot spot indicated by the arrow in the PET image was used as a point landmark to register a CT image with a PET image. This is an example of geometrical and physiological relations for establishing a more general than direct point-to-point landmark correspondences. This is the most advanced application of a-priori-knowledge in conjunction with registration applications on the basis of a Gaussian-force field as it clearly transcends purely geometric reasoning. It addresses a particular issue with molecular imaging (MI). One example is the accumulation of tracer in certain areas of an organ or a tumor like the hot spot in FIG. 6, which are visible in PET images but completely invisible in CT. In this case only approximate special neighbourhood relations can be established. Mathematically this leads to approximation schemes instead of strict interpolation.

This is particular important with improving specificity of tracer substances. Registration of molecular images with images showing anatomical contrasts, as delivered for instance by MR or CT, will become difficult or even impossible due to the loss of anatomical contrast in the MI data. The more specific a tracer, the less general tissue uptake it will show, i.e. the less anatomical contrast will appear in the MI image that may be unambiguously matched with the anatomy as it appears in the CT or MR images. Here, additional information about the relation of centers of tracer accumulation (CTAs) and anatomical entities is needed. These will have to be more general than simple point-to-point correspondences. They may be based on geometric relations restricting CTAs to certain anatomical domains such as organ boundaries, areas of certain cell or tissue types etc. They may alternatively or in addition be based on time constraints restricting the contrast ranges to match with respect to the tracer dynamics and the timing of the acquisition protocol. These relations will have to be inferred from the pharmaceutical description of the dynamic and the targeting behavior of the tracer substance at hand.

All the deformation field constraints imposed and the examples given above may be applied alone or in combination in further developed embodiments which are not described in detail here.

In summary, the invention aims at improving the point-based elastic registration paradigm. Point-based elastic registration is typically carried out by finding corresponding point landmarks 2, 4 in both images and using the point correspondences as constraints to interpolate the global displacement field. A limitation of this approach is that it only ensures the correspondences between structures where point landmarks 2, 4 can be identified. Alternative concepts are limited by high computational costs for optimization. The concept of the invention provides a method and a system 1 wherein additional deformation fields constraints are imposed by: partitioning (PART (I_{S}, I_{T})) one or more restricted structures corresponding in the first and the second image and providing additional constraints f^{Add}ₚₐᵣₜ derived from a-priori-knowledge to the one or more restricted structures. Preferred examples are i) pairs of interactively defined point landmarks 25, ii) landmarks resulting from automatic identification of corresponding structures in form of a line 23 or an area 27 or a form or a boundary (29, FIG. 3) thereof, iii) different material properties, like tissue1 and tissue2, of corresponding structures, iv) physiological constraints establishing more general correspondences.

While the invention has been described in detail, the foregoing description is in all aspects illustrative and not restrictive. It is understood that numerous other modifications and variations can be devised without departing from the scope of the invention

The features disclosed in the foregoing description, in the claims and/or in the accompanying drawings may, both separately and in any combination thereof, be material for realizing further developed configurations of the invention in diverse forms thereof.

Accordingly, the present invention is intended to embrace all such alterations, modifications and variations that fall within the spirit and scope of the appended claims. In particular any reference signs in the claims shall not be construed as limiting the scope of the invention. The wording “comprising” does not exclude other elements or steps. The wording “a” or “an” does not exclude a plurality.

### REFERENCE NUMERALS

1 system
2 point landmark
3 first image
4 point landmark
5 second image
6 deformation field
7 deformation field
11 means for determining an optimized elastic deformation field
13 means for automatically providing point landmarks
15 means for applying adaptive Gaussian-shaped forces
17 means for imposing deformation field constraints
19 means for partitioning
23 line
25 point, point landmarks
27 area
29 boundary
tissue 1 material property
tissue 2 material property
M measure
f^{G} Gaussian-shaped force
PART (I_{S}, I_{T}) partitioning step
f^{Add}ₚₐᵣₜ additional constraints

1-18. (canceled)

19. Method of model-based elastic image registration for comparing a first (3) and a second (5) image, in particular for a medical and/or a biomedical application, comprising the steps of:
determining an optimized elastic deformation field (6, 7) by optimizing a similarity measure (M) between the first (3) and the second (5) image on basis of an adaptive elastic registration,
wherein deformation field constraints are imposed by
automatically providing corresponding control point landmarks (2, 4) in the first (3) and second (5) image
applying adaptive Gaussian-shaped forces (f^{G}) as a transformation module at the control point landmarks (2, 4);
characterized in that
the step of imposing deformation field constraints further comprises:
partitioning (PART (I_{S}, I_{T})) one or more restricted structures corresponding in the first (3) and the second (5) image by segmentation of the first (3) and second (5) image,
providing additional constraints (f^{Add}ₚₐᵣₜ) derived from a-priori-knowledge to the one or more restricted structures wherein the a-priori-knowledge constraints for the restricted structure are applied as geometrical constraints and the a-priori-knowledge constraints for the restricted structure are applied as physiological constraints and the additional constraints are imposed as: an elastic property of a tissue type (tissue 1, tissue 2) of the restricted structure.

20. Method as claimed in claim 19 characterized in that the restricted structure is in form of a point (25), line (23) or area (27) or a form or a boundary (29, FIG. 3) thereof.

21. Method as claimed in claim 19 characterized in that the additional constraints are imposed as:
interactively defined corresponding point landmarks (25) in the first (3) and second (5) image.

22. Method as claimed in claim 19 characterized in that additional constraints are imposed as:
landmarks resulting from automatic, semi-automatic or interactive identification of corresponding lines (23), areas (27) or boundaries (29, FIG. 3) in the first (3) and second (5) image.

23. Method as claimed in claim 19 characterized in that a physiological constraint is with regard to a material property (tissue 1, tissue 2) or a time constraint of the restricted structure (FIG. 6) or a spatial neighborhood relation.

24. Method as claimed in claim 19 characterized in that the additional constraints are selected as:
automatic, semi-automatic or interactive identification.

25. Method as claimed in claim 19 characterized in that
boundary conditions are provided at least for some points of the boundaries (29, FIG. 3) between the restricted structures.

26. System (1) for model-based elastic image registration for comparing a first (3) and a second (5) image, in particular for a medical and/or a biomedical application, comprising:
means (11) for determining an optimized elastic deformation field (6, 7) by optimizing a similarity measure (M) between the first (3) and the second (5) image on basis of an adaptive elastic registration,
means (17) for imposing deformation field constraints, comprising
means (13) for automatically providing corresponding control point landmarks (2, 4) in the first (3) and second (5) image
means (15) for applying adaptive Gaussian-shaped forces (f^{G}) as a transformation module at the control point landmarks (2, 4);
characterized in that
the means (17) for imposing deformation field constraints further comprises:
means (19) for partitioning one or more restricted structures corresponding in the first (3) and the second (5) image by segmentation of the first (3) and second (5) image
means (21) for providing additional constraints (f^{Add}ₚₐᵣₜ) derived from a-priori-knowledge to the one or more restricted structures, wherein a-priori-knowledge constraints for the restricted structure are in form of geometrical constraints and a-priori-knowledge constraints for the restricted structure in form of physiological constraints and additional constraints an in form of an elastic property of tissue type (tissue 1, tissue 2) of the restricted structure.

27. System (1) as claimed in claim 26 characterized in that the restricted structure is in form of a point (25), line (23) or area or a form or a boundary thereof

28. System (1) as claimed in claim 26 characterized in that a physical constraint is with regard to a material property (tissue1, tissue2) or a time constraint of the restricted structure.

29. System (1) as claimed in claim 26 characterized by means for automatic, semi-automatic or interactive identification of the additional constraints.

30. Image acquisition device comprising the system (1) as claimed in claim 27.

31. Image workstation comprising the system (1) as claimed in claim 26.

32. Computer program product storable on a medium readable by a computing, imaging and/or printer system, comprising a software code section which induces the computing, imaging and/or printer system to execute the method as claimed in claim 19 when the product is executed on the computing, imaging and/or printer system.

33. Information carrier comprising the computer program product as claimed in claim 32.
